(19) United States
(12) Patent Application Publication
(10) Pub. No.: US 2025/0383552 A1
(43) Pub. Date: Dec. 18, 2025

(54) ARTISTIC EXPRESSION WITH POLARIZED MATERIALS

(71) Applicant: William Maxwell, Decatur, GA (US)

(72) Inventor: William Maxwell, Decatur, GA (US)

(21) Appl. No.: 18/876,072

(22) PCT Filed: Jun. 23, 2023
(86) PCT No.: PCT/US2023/026134

§ 371 Date: Dec. 17, 2024

Related U.S. Application Data
(60) Provisional application No. 63/354,985, filed on Jun. 23, 2022.

(51) Int. Cl. G02B 27/28; A63H 33/22

(52) U.S. Cl. CPC G02B 27/286; A63H 33/22

(57) ABSTRACT

A first layer of transparent polarized material is present. A second layer of transparent polarized material has a polarization opposite the first layer of transparent material. The first layer and the second layer partially define a cavity configured to receive a sheet of transparent non-polarized material between the first layer and the second layer.

### CROSS-REFERENCE TO RELATED APPLICATIONS

This patent application claims priority to and the benefit of U.S. Provisional Patent Application No. 63/354,985, filed on Jun. 23, 2022, which is incorporated herein by reference in its entirety.

### TECHNICAL FIELD

This disclosure relates to an artistic toy.

### BACKGROUND

Polarized filters are configured to block certain polarities of light waves. For example, polarized sunglasses use linear polarized filters oriented to attenuate horizontal reflections using such a technique. Polarized filters can include filters for linear polarized light and/or filters for circular polarized light. In some instances, polarized filters can be used to visualize stress in a transparent medium. Such a technique relies upon stress induced birefringence, which results in a colored pattern which correlates with the stress within the transparent medium.

### SUMMARY

This disclosure describes technologies relating to artistic expression with polarized materials.

An example of the subject matter described within this disclosure is a device with the following features. A first layer of transparent polarized material is present. A second layer of transparent polarized material has a polarization opposite the first layer of transparent material. The first layer and the second layer partially define a cavity configured to receive a sheet of transparent non-polarized material between the first layer and the second layer.

Aspects of the example device, which can be combined with the example device alone or in combination, include the following. A first frame supports the first layer of transparent polarized material and a second frame supports the second layer of transparent polarized material.

Aspects of the example device, which can be combined with the example device alone or in combination, include the following. Lights are positioned to shine through the first layer of transparent polarized material and the second layer of transparent polarized material.

Aspects of the example device, which can be combined with the example device alone or in combination, include the following. A mirror is arranged to receive light from the lights and direct the light onto a surface.

Aspects of the example device, which can be combined with the example device alone or in combination, include the following. A lens is arranged to focus the light onto the surface.

Aspects of the example device, which can be combined with the example device alone or in combination, include the following. A transparent support surface is between the first layer of transparent polarized material and the second layer of transparent polarized material. The transparent support surface is configured to support the sheet of transparent non-polarized material.

Aspects of the example device, which can be combined with the example device alone or in combination, include the following. The first layer of transparent polarized material and the second layer of transparent polarized material include circular polarized material.

An example of the subject matter described within this disclosure is a method that includes the following features. A first layer of transparent polarized material is provided. A second layer of transparent polarized material is provided. The second layer of transparent polarized material has an opposite polarization to the first layer of transparent polarized material. A layer of transparent non-polarized material to be placed between the first layer and the second layer is provided.

Aspects of the example method, which can be combined with the example method alone or in combination, include the following. The transparent polarized material of the first layer and the transparent polarized material of the second layer are circularly polarized.

Aspects of the example method, which can be combined with the example method alone or in combination, include the following. A transparent support surface is provided between the first layer of transparent polarized material and the second layer of transparent polarized material. The transparent support surface is configured to support the layer of transparent non-polarized material.

Aspects of the example method, which can be combined with the example method alone or in combination, include the following. A light box is provided. The first layer is between the light box and the transparent support surface.

Aspects of the example method, which can be combined with the example method alone or in combination, include the following. An image is projected upon a surface by a lens and the light box.

Aspects of the example method, which can be combined with the example method alone or in combination, include the following. The layer of transparent non-polarized material includes a material configured to deform upon an application of pressure provided by a writing utensil or drawing utensil.

An example of the subject matter described within this disclosure is a toy with the following features. A first layer of transparent polarized material is present. A second layer of transparent polarized material has a polarization opposite the first layer of transparent material. The first layer and the second layer partially define a cavity. A sheet of transparent non-polarized material is between the first layer and the second layer.

Aspects of the example toy, which can be combined with the example toy alone or in combination, include the following. A first frame supports the first layer of transparent polarized material and a second frame supports the second layer of transparent polarized material.

Aspects of the example toy, which can be combined with the example toy alone or in combination, include the following. Lights are positioned to shine through the first layer of transparent polarized material and the second layer of transparent polarized material.

Aspects of the example toy, which can be combined with the example toy alone or in combination, include the following. A mirror is arranged to receive light from the lights and direct the light onto a surface.

Aspects of the example toy, which can be combined with the example toy alone or in combination, include the following. A lens is arranged to focus the light onto the surface.

Aspects of the example toy, which can be combined with the example toy alone or in combination, include the following. A transparent support surface is between the first layer of transparent polarized material and the second layer of transparent polarized material. The transparent support surface is configured to support the sheet of transparent non-polarized material.

Aspects of the example toy, which can be combined with the example toy alone or in combination, include the following. The first layer of transparent polarized material and the second layer of transparent polarized material include circular polarized material.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a cross-sectional schematic view of an example artistic toy layout.

FIG. 2 is a cross-sectional schematic view of an example artistic toy layout.

FIG. 3 is a cross-sectional schematic view of an example artistic toy layout.

FIG. 4 is a flowchart of an example method that can be used with aspects of this disclosure.

Like reference numbers and designations in the various drawings indicate like elements.

### DETAILED DESCRIPTION

When one views an image through two polarizers of opposite polarization, the viewer is unable to see anything but dark field. When certain transparent materials, such as cellophane and some transparent sheet plastics, are placed between two polarizers of opposite polarization, and those transparent materials are placed under some form of stress, the result is a display of brilliant, fiery colors. As these materials are moved about between these polarizers or are placed under further stress, the colors will shift and change dramatically in an entertaining manner. If an individual writes or draws on the transparent sheet, the result will be brilliant colors everywhere the stylus impresses the transparent sheet. The individual may also use their fingers or nails to create a vivid color effect.

This disclosure describes a toy with a first layer of transparent polarized material. A second layer of transparent polarized material has a polarization opposite the first layer of transparent material. The first layer and the second layer partially define a cavity configured to receive a sheet of transparent non-polarized material between the first layer and the second layer. In some implementations, the toy is supplied with a certain amount of the transparent non-polarized sheets.

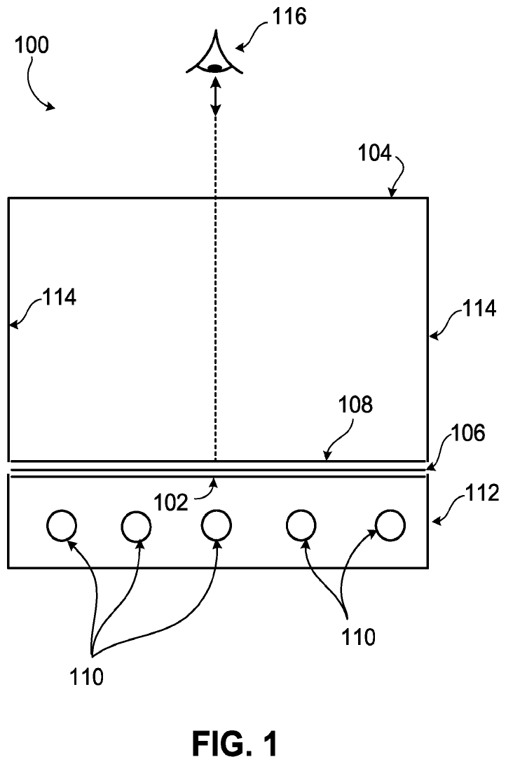

FIG. 1 is a cross-sectional schematic view of an example artistic toy layout 100. The toy includes a first layer 102 of transparent polarized material. A frame or other support structure supports the first layer 102 of transparent polarized material. A transparent support surface is located between the first layer 102 of transparent material and a second layer 104 of transparent material. The transparent support surface 106 is configured to support a sheet 108 of transparent non-polarized material. In some implementations, the transparent support surface can act as the frame or other support structure to fully or partially support the first layer 102. In some implementations, the support surface includes a hard glass or plastic diffusing layer with the first layer 102 below or lamented under it illuminated by a light source (such as lights 110). In some implementations, an additional frame is used to hold the transparent non-polarized sheet 108 in place so that an individual can draw or write on the sheet with a variety of styluses of differing sharpness or bluntness.

In some implementations, the transparent support surface 106 and the first layer 102 rest atop a light box 112. The light box 112 defines an interior that includes lights, such as LEDs, which shine light up through the transparent support surface 106 and the first layer 102 rest atop a light box 112.

A second layer 104 of transparent polarized material is located a sufficient distance from the support surface 106 to allow a hand and/or writing/drawing utensil access to the support surface 106. The first layer 102 and the second layer 104 (or the support surface 106) partially define a cavity configured to receive a sheet 108 of transparent non-polarized material between the first layer and the second layer. In some implementations, a second frame supports the second layer 104 of transparent polarized material. In some implementations, the second layer 104 is substantially parallel to the first layer 102, the support surface, or both. The second layer 104 has a polarization opposite of the first layer 102. For example, in implementations where the first layer includes a clockwise, circular polarization, the second layer would include a counter clockwise, circular polarization. While primarily described throughout this disclosure as using circular polarized layers, linearly polarized layers can be used without departing from this disclosure. In some implementations, the second layer is held above the light box 112 and support surface 106 by collapsible struts 114 so the device may be folded down for compactness. In some implementations, a mirror or mirrors may be used to make the device more compact. In some implementations, the first layer or the second layer are rotatable, in the same plane, relative to one another. Such rotation can be used to show different color variations.

In operation, an individual 116 is able to view the non-polarized sheet 108 through the second layer. The light shines through the first layer 102, the support surface 106, the non-polarized sheet 108, and the second layer 104 prior to striking the individual's eye.

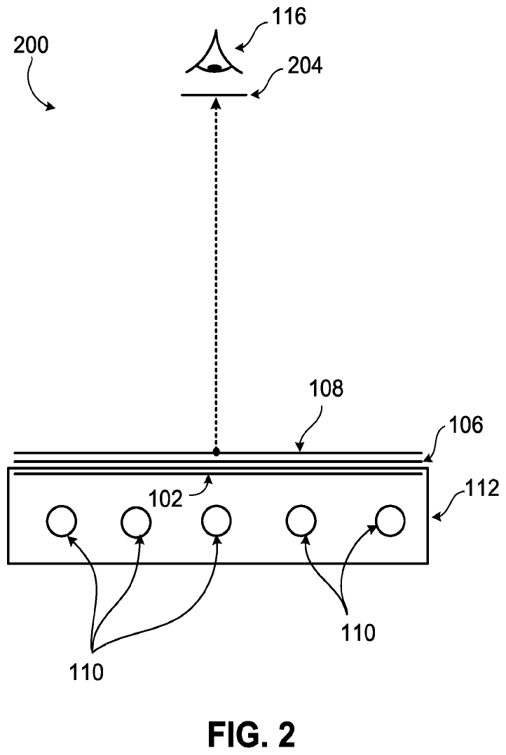

FIG. 2 is a cross-sectional schematic view of an example artistic toy layout 200. The artistic toy layout 200 is substantially similar to the artistic toy layout 100 previously described with the exception of any differences described herein. In the layout 200, the individual 116 relies upon polarized glasses 204 in lieu of the second layer 104. While linear polarizers may be used for this version, circular polarizers are preferred since they would not be sensitive to the tilt of the individual's head changing the polarization angle.

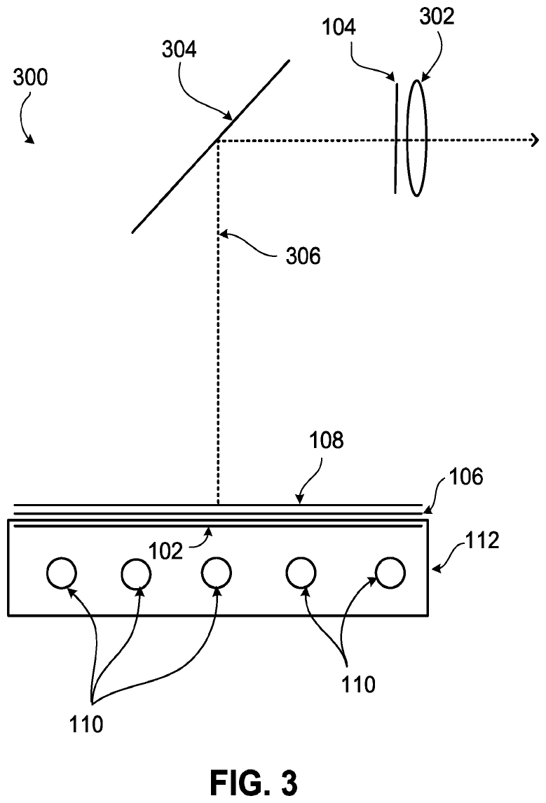

FIG. 3 is a cross-sectional schematic view of an example artistic toy layout 300. The artistic toy layout 300 is substantially similar to the artistic toy layout 100 previously described with the exception of any differences described herein. In the layout 300, a lens 302, or a lens 302 and a mirror 304 are used in lieu of the second layer 104. Such an implementation allows colored images produced by the layout 300 to be projected onto a screen, a wall, a ceiling, a tabletop, or other surface. There is a second polarizer layer 104 in the optical path 306 which can be located on either side of the lens 302 and mirror 304. The mirror 304 can be on either side of the lens 302. In some implementations, a Fresnel lens of suitable focal length is included under the support surface 106 to help concentrate the light onto the lens 302 thereby increasing the brightness of the projected image. The lens 302 and mirror 304 can be tilted so as to change the angle (elevation) of the projected image.

The implementations described herein can be mixed and matched with one another, for example, a convertible layout that can include the second layer 104 and a lens 302/mirror 304 assembly that can be interchanged with one another.

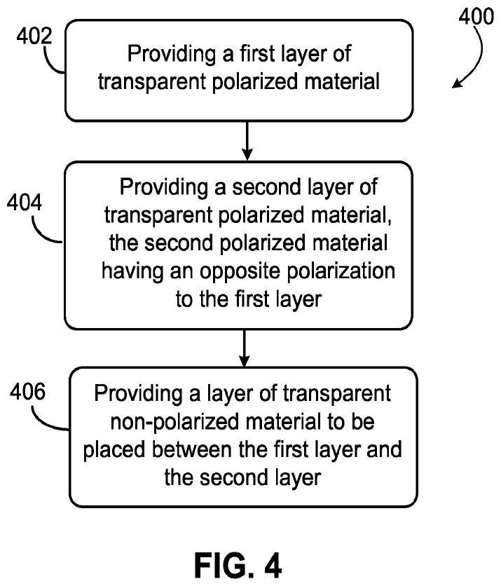

FIG. 4 is a flowchart of an example method 400 that can be used with aspects of this disclosure. At 402, a first layer of transparent polarized material is provided. At 404, a second layer of transparent polarized material is provided. The second polarized material has an opposite polarization to the first layer. In some implementations, the first polarized material and the second polarized material are circularly polarized. In some implementations, the first polarized material and the second polarized material are linearly polarized.

At 406, a layer of transparent non-polarized material is provided. The layer of transparent non-polarized material is configured to be placed between the first layer and the second layer. The non-polarized layer includes a material configured to deform upon an application of pressure, for example, provided by a writing utensil and/or drawing utensil.

In some implementations, a transparent support surface is provided. The transparent support surface is configured to be positioned between the first layer of transparent polarized material and the second layer of transparent polarized material. In some implementations, the first polarized material is attached, for example, as a film, upon a surface of the support surface. The transparent support surface is configured to support the non-polarized material.

In some implementations, a light box is provided. The first layer is between the light box and the support surface. In some implementation, an image created by the first layer, the second layer, and the non-polarized material, is projected upon a surface by a lens and the light box. Such a surface can include a wall, a projector screen, a ceiling, or a tabletop.

In some implementations, in addition to using two circular polarizers or two linear polarizers, a circular polarizer and a linear polarizer can be used together in the proper orientation since a circular polarizer includes a linear polarizer with a phase shifter layer. A “circular” polarizer will pass both circular and linear polarized light depending which direction the light is coming through. If the light enters from the linear polarizer side of the circular polarizer, the exiting light will be circularly polarized. If the light enters from the phase shifting side of the circular polarizer, the exiting light will be linearly polarized. A linear polarizer layer may be sandwiched between two phase shifting layers to analyze incoming circular polarized light and produce outgoing circular polarized light.

While this disclosure contains many specific implementation details, these should not be construed as limitations on the scope of what may be claimed, but rather as descriptions of features specific to particular implementations. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described components and systems can generally be integrated together in a single product or packaged into multiple products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A device comprising:
a first layer of transparent polarized material; and
a second layer of transparent polarized material having a polarization opposite the first layer of transparent material, the first layer and the second layer partially defining a cavity configured to receive a sheet of transparent non-polarized material between the first layer and the second layer.

2. The device of claim 1, further comprising a first frame supporting the first layer of transparent polarized material and a second frame supporting the second layer of transparent polarized material.

3. The device of claim 1, further comprising lights positioned to shine through the first layer of transparent polarized material and the second layer of transparent polarized material.

4. The device of claim 3, further comprising a mirror arranged to receive light from the lights and direct the light onto a surface.

5. The device of claim 4, further comprising a lens arranged to focus the light onto the surface.

6. The device of claim 1, further comprising a transparent support surface between the first layer of transparent polarized material and the second layer of transparent polarized material, the transparent support surface configured to support the sheet of transparent non-polarized material.

7. The device of claim 1, wherein the first layer of transparent polarized material and the second layer of transparent polarized material include circular polarized material.

8. A method comprising:
providing a first layer of transparent polarized material;
providing a second layer of transparent polarized material, the second layer of transparent polarized material having an opposite polarization to the first layer of transparent polarized material; and
providing a layer of transparent non-polarized material to be placed between the first layer and the second layer.

9. The method of claim 8, wherein the transparent polarized material of the first layer and the transparent polarized material of the second layer are circularly polarized.

10. The method of claim 8, further comprising providing a transparent support surface between the first layer of transparent polarized material and the second layer of transparent polarized material, the transparent support surface configured to support the layer of transparent non-polarized material.

11. The method of claim 10, further comprising providing a light box, the first layer being between the light box and the transparent support surface.

12. The method of claim 11, further comprising:
projecting an image, by a lens and the light box, upon a surface.

13. The method of claim 8, wherein the layer of transparent non-polarized material comprises a material configured to deform upon an application of pressure provided by a writing utensil or a drawing utensil.

14. A toy comprising:
a first layer of transparent polarized material;
a second layer of transparent polarized material having a polarization opposite of the first layer of transparent material, the first layer and the second layer partially defining a cavity; and
a sheet of transparent non-polarized material between the first layer and the second layer.

15. The toy of claim 14, further comprising a first frame supporting the first layer of transparent polarized material and a second frame supporting the second layer of transparent polarized material.

16. The toy of claim 14, further comprising lights positioned to shine through the first layer of transparent polarized material and the second layer of transparent polarized material.

17. The toy of claim 16, further comprising a mirror arranged to receive light from the lights and direct the light onto a surface.

18. The toy of claim 17, further comprising a lens arranged to focus the light onto the surface.

19. The toy of claim 14, further comprising a transparent support surface between the first layer of transparent polarized material and the second layer of transparent polarized material, the transparent support surface configured to support the sheet of transparent non-polarized material.

20. The toy of claim 14, wherein the first layer of transparent polarized material and the second layer of transparent polarized material include circular polarized material.
